(19) United States
(12) Patent Application Publication
(10) Pub. No.: US 2002/0172390 A1
(43) Pub. Date: Nov. 21, 2002

(54) Hearmuff

(76) Inventor: Alan Charles Roberts, New York, NY (US)

Correspondence Address: Deborah K. Patrick, T.T. Communications, Inc., 139 Fulton Street, Ste 201, New York, NY, 10038, US

(21) Appl. No.: 09/858,745

(22) Filed: May 17, 2001

(51) Int. Cl. H04R 25/00

(52) U.S. Cl. 381/370

(57) ABSTRACT

The Hearmuff is double-sided felt material that covers your ears by wrapping the product around your head, covering your ears to keep them warm. It contains earphones, one for each ear that is surrounded within the earmuffs. It is adjusted by the Velcro at both ends and is used for entertainment while keeping the ears warm during cold weather.

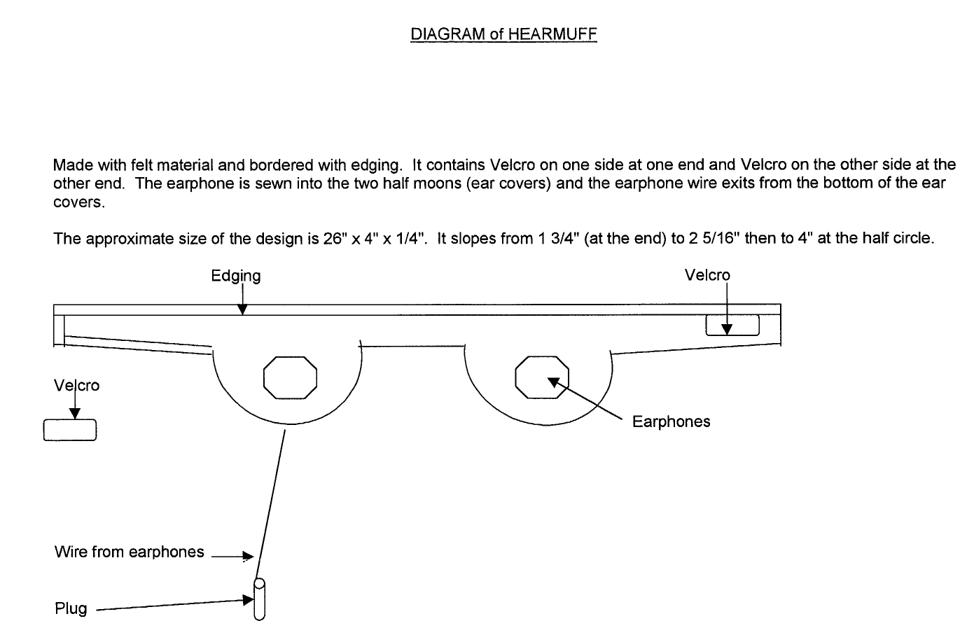

What I claim as my invention is a product known as “Hearmuff”. This is a design of winter headband type apparel that has built-in headphones. When connected to any hand-held, portable television or stereo unit, this headband allows the person to hear pre-recorded music, live radio or television broadcasts. At the same time the person wearing the Hearmuffs benefits from keeping his/her ears warm in cold weather. It is anticipated that this product will contain various logos on its front and/or sides, upon approval from the proper licensing authorities.

The product is made of fleece material for the inner and outer shells and surrounds the headphones. The headphone speakers are sewn near the ear area with the cord exiting from one of the ear sides, allowing it to be plugged into the selected portable device using a standard mini-plug, or with an RCA plug adapter. The back of the product contains Velcro to allow the wearer to adjust it to fit to his/her head.

This product will be manufactured for resale to the general public and/or other entity.

The dimensions of the product are as follows:

26″×4″ (sloping to 2 5/16″ and 1¾″)×¼″

A diagram of the product is attached hereto and made a part hereof.

### BACKGROUND OF THE INVENTION

Use as earwarmers until design of earphones placed inside earwarmers for entertainment purposes.

### SPECIFICATION

The Hearmuff was invented by Alan C. Roberts for designing a winter, headband type cover for the ears. The Hearmuff has built-in earphones to allow the wearer to plug it in to portable CD player, television, and/or stereo. The Hearmuff are used for both warmth and listening enjoyment.

The design of the Hearmuff allows for the warmth of the ears as it is worn. It wraps around the forehead and the Velcro in the back is used to adjust it to fit the person's head.

It is made using one piece of felt/fleece that is cut on the seam of the material. The earphones are sewn into one side of the ear section and the two sides are then sewn together (with earphones on the inside) using the edging/trim. The wire from the earphones exits on the left side of the hearmuff at the ear section. Velcro is added to the back two end pieces, one strip on the outer side and one strip on the inner side to allow the two pieces to join together to hold it to the head and adjust the fit.

This product will have various NFL/NHL/NCAA/NASCAR team logos sewn onto the front of the Hearmuff (at the forehead section) and will be sold online, in magazines, at stadiums, retail stores for the public.

1. The claim for this invention is that there is presently nothing on the market like it. There are headphones that are worn over the ears, but none that are designed like the Hearmuff. The design of the Hearmuff is unique with the logos on the front of the headband, the earphones sewn into the inside of the ear covers so that they do not move around inside, the Velcro allows for the right fit adjustment and the earphone plug also comes with a television adapter plug. The fleece material allows for warmth of the ears during the cold months and that coupled with the earphones allows a person to listen to music and/or watch television while wearing the Hearmuff outdoors.
